(19) United States
(12) Patent Application Publication
(10) Pub. No.: US 2019/0333300 A1
(43) Pub. Date: Oct. 31, 2019

(54) METHOD OF PARAMETERIZATION OF A CONTROL DEVICE

(71) Applicant: FEV Europe GmbH, Aachen (DE)

(72) Inventor: Georg Eisele, Aachen (DE)

(21) Appl. No.: 16/391,356

(22) Filed: Apr. 23, 2019

(30) Foreign Application Priority Data
Apr. 25, 2018 (DE) 102018109931.2

(51) Int. Cl. G07C 5/08

(52) U.S. Cl. CPC G07C 5/0833; G07C 5/085

(57) ABSTRACT

The invention relates to a method for the automated parameterization of a control device (1) for a vehicle (2) with an engine, wherein the control device (1) is designed for active sound design, based on target data (3), current data (4) and output data (5), and comprises the steps of:
a) measuring the current data (4) of the vehicle (1);
b) comparing the target data (3) with the current data (4);
c) calculating the output data (5) on the basis of step b);
d) parameterizing the control device (1) with the output data (5);
e) designing the sound of the vehicle (2) on the basis of the output data (5).

### CROSS-REFERENCE TO RELATED APPLICATIONS

This Application claims priority from Application 102018109931.2 filed on Apr. 25, 2018 in Germany.

### FIELD OF THE INVENTION

The invention relates to a method for the parameterization of a control device for a vehicle, a computer program product, a control device, a vehicle and a system.

### BACKGROUND OF THE INVENTION

DE102015225990A1 discloses a method for synthesizing the driving noise for a vehicle.

Vehicles, in particular vehicles with engines, generate a sound when the vehicle is operating. The sound is perceptible, inter alia, for a driver in the driver's compartment of the vehicle. The sound depends in particular on current engine parameters of the engine, such as the speed of rotation of the engine and/or the torque that the engine is transmitting. The sound thus permits conclusions to be drawn as to the type and state of the vehicle.

The sound comprises various frequencies. The rotation speed of the engine, as well as higher and lower orders of the rotation speed of the engine, are included within these frequencies. The rotation speed and other orders of the rotation speed are also referred to as engine orders.

Vehicle components such as turbochargers and/or particle filters can change the sound of the vehicle. The change here comprises changes to the frequency of the sound and/or the sound pressure level of the sound. Active sound design is employed for vehicles in order to change the sound for current engine parameters. In particular, changes to the sound that lead to a euphonious sound that supplies simultaneous feedback on the current state of the vehicle to the driver, e.g. through a characteristic dependency of the torque, are desired here.

The output data comprise sound data that can be generated by a loudspeaker system. The current data comprise current sound data of the vehicle for current engine parameters. The sound that is generated in total by the vehicle comprises the sound based on the current engine parameters and the sound based on the output data. Target data comprise target sound data that are taken into account in the calculation of the output data while taking the current data into account. Target sound data preferably comprise euphonious sounds with a characteristic dependency on the torque.

The method according to the invention for the automated parameterization of a control device for a vehicle with an engine, wherein the control device is designed for active sound design, comprises the steps of:
a) measuring the current data of the vehicle;
b) comparing the target data with the current data;
c) calculating the output data on the basis of step b);
d) parameterizing the control device with the output data;
e) designing of the sound of the vehicle on the basis of the output data.

In a preferred form of embodiment, the steps a) to e) are carried out in an automated and/or partially automated manner. A time saving in the parameterization of the control device is thereby enabled. The output data can, in addition, be used for an entire series of the same vehicle. The output data thus only have to be transferred to the respective control device without calculating the output data again. The vehicles of the series can differ here in features that have no influence on the sound of the vehicle. The method according to the invention thus enables an additional time saving for the parameterization of control devices of vehicles of a series.

The method according to the invention permits the adaptation of the sound of the vehicle to a target sound that is based on the target data. A specific sound of the vehicle is thereby enabled. This specific sound is preferably euphonious and/or gives expression to the sportiness of the vehicle. A more precise acoustic assessment of the vehicle state is furthermore enabled, which increases safety during the operation of the vehicle.

The computer program product according to the invention comprises a program which, when it is executed by a computer, causes the computer to carry out a method according to the invention.

The control device according to the invention is parameterized with output data which are calculated in accordance with a method according to the invention.

The vehicle according to the invention comprises a control device according to the invention.

The system according to the invention is designed for the automatic parameterization of a control device according to the invention.

The advantage of the method according to the invention is thus also enabled for the computer program product according to the invention, the control device according to the invention, the vehicle according to the invention and the system according to the invention.

The dependent claims describe further advantageous forms of embodiment of the invention.

### BRIEF DESCRIPTION OF THE DRAWINGS

FIG. 1 is a diagram showing use of the method.

### DETAILED DESCRIPTION OF PREFERRED EMBODIMENT

A preferred exemplary embodiment is explained in more detail with reference to the following figure.

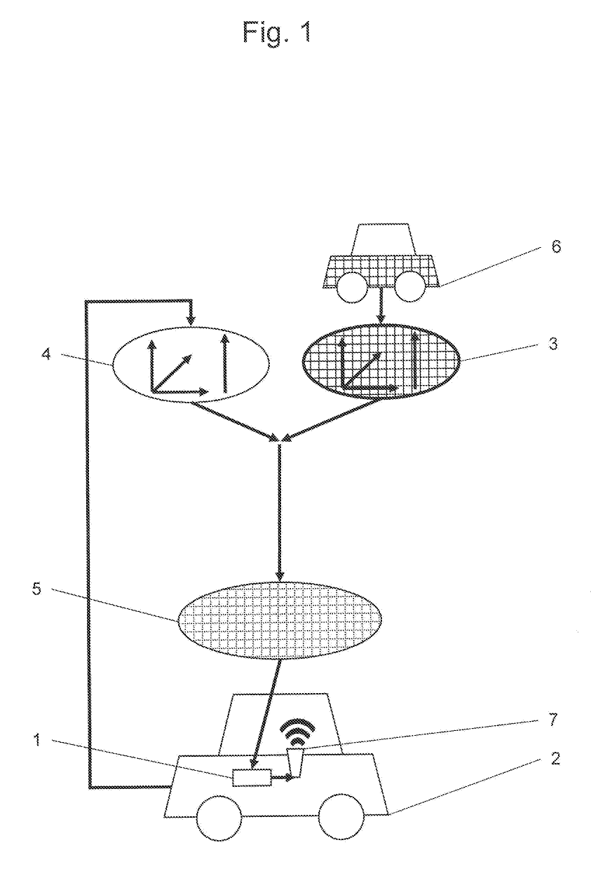

FIG. 1 shows a vehicle 2 according to the invention with a control device 1 according to the invention which is designed for active sound design. The method according to the invention for the automated parameterization of the control device 1 for the vehicle 2 with an engine comprises the steps of:
a) measuring current data 4 of the vehicle 2;
b) comparing target data 3 with the current data 4;
c) calculating output data 5 on the basis of step b);
d) parameterizing the control device 1 with the output data 5;
e) designing the sound of the vehicle on the basis of the output data 5.

In addition, the target data 3 are generated at least four-dimensionally, and/or the current data 4 are measured at least four-dimensionally, and/or the output data 5 are calculated at least four-dimensionally, wherein the first dimension corresponds to a frequency of a sound of the vehicle 2, and wherein the second dimension corresponds to a sound pressure level of the sound of the vehicle 2, and wherein the third dimension corresponds to a speed of rotation of the engine, and wherein the fourth dimension corresponds to the torque of the engine.

The measurement of the current data 4 of the vehicle 2 is performed directly at the vehicle 2 in this exemplary embodiment. Sound generated by the vehicle for a current speed of rotation and a current torque are recorded here. The simulation of the current data is another possibility. The simulation is carried out here on the control device 1 or on an external computer. The current data 4 are stored in the control device 1 and/or on an external computer.

A data record from a target vehicle 6 is furthermore taken into account for the target data 3.

The target data 3 preferably take into account noise data of a target vehicle 6 which already generates a euphonious and/or sporty sound, and which permit a precise acoustic analysis of the vehicle state. The target data 3 are measured directly at the target vehicle 6 in this exemplary embodiment. Sounds of the target vehicle 6 are recorded here depending on the current speed of rotation and the current torque. Taking simulations of the sound into account for the target data 3 is a further possibility. The simulation is carried out here on the control device 1 and/or on an external computer. The target data 3 are stored in the control device and/or on an external computer. Taking manual adaptations into account, for example by an acoustic engineer, is also a further possibility for the target data 3.

The sounds of the target vehicle 6 can then be further adapted in order to generate optimized target data 3. Preferred engine orders are, for example, amplified and/or attenuated here.

The target data 3, furthermore, are stored in a first characteristic map, and/or the current data 4 in a second characteristic map, and/or the output data 5 in a third characteristic map.

The storage of the target data 3 and/or of the current data 4 and/or of the output data 5 in characteristic maps permits fast access to the data. The storage of the data in characteristic maps furthermore simplifies automation of the data recording and/or the data-processing. The measurement of the current data 4 is thus carried out automatically for corresponding speeds of rotation and torques, and the associated sound stored in the characteristic map at the corresponding location in the characteristic map. For the comparison, the sound data from the current data 4 are compared with the sound data based on the target data 3. Automation is again simplified here through storing the data in characteristic maps. A subtraction of the target data 3 and the current data 4 is preferably suitable for the calculation of the output data 5. Other mathematical operations are alternatively also possible for calculating the output data 5. The calculation of the output data 5 takes place automatically for the respective entries in the characteristic maps.

The control device 5 is parameterized with the output data 5. The storage of the output data 5 takes place on the control device 1 in a characteristic map, which makes it possible for the control device 1 to access the corresponding data record from the output data 5 for a current speed of rotation and a current torque.

The automation therefore permits a time saving in the calculation of the output data 5 and the parameterization of the control device 1.

In addition, the output data 5 are converted into a sound by loudspeaker equipment 7 of the vehicle 2.

The loudspeaker equipment 7 generates sounds on the basis of the output data 5. Together with the current sounds that the vehicle 2 causes without additional sounds, the sounds generated in this way result in sounds similar to the target sounds that are based on the target data 3. A total sound of the vehicle 2 that corresponds to the target sound results from this.

The frequency and the associated sound pressure level here result in the sound of the vehicle 2 for the corresponding speed of rotation of the engine and the corresponding torque that the motor transfers at the corresponding speed of rotation. A target sound that is euphonious and/or sporty for every speed of rotation and every torque is enabled through the design of the sound depending on the speed of rotation and the torque of the engine. A more precise acoustic assessment of the vehicle state is furthermore enabled for every speed of rotation and every torque, which increases safety during the operation of the vehicle.

The computer program product according to the invention comprises a program which, when it is executed by a computer, causes the computer to carry out a method according to the invention.

The vehicle according to the invention comprises a control device according to the invention.

The system according to the invention is designed for the automatic parameterization of a control device according to the invention.

1. A method for the automated parameterization of a control device for a vehicle with an engine, wherein the control device is designed for active sound design, comprising the steps of:
a) measuring current data of the vehicle;
b) comparing target data with the current data;
c) calculating output data on the basis of step b);
d) parameterizing the control device with the output data;
e) designing of the sound of the vehicle on the basis of the output data.

2. The method according to claim 1, wherein the target data is generated at least three-dimensionally, and/or the current data is measured at least three-dimensionally, and/or the output data is calculated at least three-dimensionally, and wherein the first dimension corresponds to a frequency of a sound of the vehicle, and wherein the second dimension corresponds to a sound pressure level of the sound of the vehicle, and wherein the third dimension corresponds to a speed of rotation of the engine.

3. The method according to claim 2, wherein the target data is generated at least four-dimensionally, and/or the current data is measured at least four-dimensionally, and/or the output data is calculated at least four-dimensionally, and wherein the fourth dimension corresponds to a torque of the engine.

4. The method according to claim 1, wherein the target data is stored in a first characteristic map, and/or the current data is stored in a second characteristic map, and/or the output data is stored in a third characteristic map.

5. The method according to claim 1, wherein a data record from a target vehicle is taken into account for the target data.

6. The method according to claim 1, wherein the output data is converted into a sound by loudspeaker equipment of the vehicle.

7. A computer program product comprising:
a program which, when it is executed by a computer, which is adapted to cause the computer to measure current data of the vehicle;
compare target data with the current data;
calculate output data on the basis of comparing the target data with the current data;
parameterize the control device with the output data;
design the sound of the vehicle on the basis of the output data.

8. A control device parameterized with output data which is calculated by
a) measuring current data of the vehicle;
b) comparing target data with the current data;
c) calculating output data on the basis of step b);
d) parameterizing the control device with the output data;
e) designing of the sound of the vehicle on the basis of the output data.

9. A vehicle comprising a control device which measures current data of the vehicle;
compares target data with the current data;
calculates output data on the basis of the comparison;
parameterizes the control device with the output data; and
designs the sound of the vehicle on the basis of the output data.

10. A system designed for the automatic parameterization of a control device comprising sensors for measuring current data of the vehicle;
a control device which compares target data with the current data;
the control device calculating output data on the basis;
parameterizing the control device with the output data;
designing of the sound of the vehicle on the basis of the output data.
